(19) United States
(12) Patent Application Publication
(10) Pub. No.: US 2009/0238930 A1
(43) Pub. Date: Sep. 24, 2009

(54) METHODS FOR PRODUCING POWDERED, PROTEIN-RICH COMESTIBLES

(76) Inventor: Subramaniam Sathivel, Baton Rouge, LA (US)

Correspondence Address: Ballard Spahr Andrews & Ingersoll, LLP, SUITE 1000, 999 PEACHTREE STREET, ATLANTA, GA, 30309-3915, US

(21) Appl. No.: 12/369,452

(22) Filed: Feb. 11, 2009

Related U.S. Application Data
(60) Provisional application No. 61/028,318, filed on Feb. 13, 2008.

(51) Int. Cl. A23J 1/04; A23J 3/00; A23J 1/00

(52) U.S. Cl. 426/238; 426/472; 426/431; 426/422; 426/657; 426/656

(57) ABSTRACT

In one aspect, the invention relates to powdered, protein-rich comestibles and methods for producing same. Disclosed are powdered, protein-rich comestibles having a protein content of at least about 65%, a moisture content of less than about 5%, and a lipid content of less than about 10%, wherein the powder has an average particle size of less than about 65 μm. In one aspect, comestibles can be derived from fish sources. Also disclosed are methods for producing powdered, protein-rich comestibles by isolating soluble proteins from a mixture of water and comminuted raw fish product and drying the isolate to a powder. This abstract is intended as a scanning tool for purposes of searching in the particular art and is not intended to be limiting of the present invention.

### CROSS-REFERENCE TO RELATED APPLICATIONS

This application claims the benefit of U.S. Application No. 61/028,318, filed Feb. 13, 2008, which is hereby incorporated herein by reference in its entirety.

### ACKNOWLEDGMENT

This invention was made with government support under NOAA grant number NA16RG2321 awarded by the National Oceanic and Atmospheric Administration. The United States government has certain rights in the invention.

### BACKGROUND

Currently, soy and milk proteins are widely used in many segments of the food industry, while amino acids and peptides are gaining popularity for use in energy drinks and other applications. Protein can also be obtained from low price wild marine fish that are underutilized, for example arrowtooth flounder, a flatfish plentiful in Alaskan waters. While high quality protein can also be derived from such fish sources, using arrowtooth flounder as human foods can be challenging due to proteolytic enzymes that soften the flesh during cooking, making it undesirable for many consumers.

Therefore, there remains a need for methods and compositions that overcome these deficiencies and that effectively provide for low-fat, high-protein comestibles derived from fish sources.

### SUMMARY

In accordance with the purpose(s) of the invention, as embodied and broadly described herein, the invention, in one aspect, relates to powdered, protein-rich comestibles and methods for producing same.

Thus, disclosed are powdered, protein-rich comestibles comprising a protein content of at least about 65%, a moisture content of less than about 5%, and a lipid content of less than about 10%, wherein the powder has an average particle size of less than about 65 μm. In one aspect, comestibles can be derived from fish sources.

Also disclosed are methods for producing a powdered, protein-rich comestible comprising the steps of isolating soluble proteins from a mixture of water and comminuted raw fish product; and drying the isolate to a powder.

Also disclosed are products produced by the disclosed methods.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### BRIEF DESCRIPTION OF THE FIGURES

The accompanying figures, which are incorporated in and constitute a part of this specification, illustrate several aspects and together with the description serve to explain the principles of the invention.

FIG. 1 is a graph showing the effect of hydrolysis time on degree of hydrolysis (% dh) of arrowtooth flounder fillets. Points are means of triplicate determinations with standard error bars.

FIG. 2 shows SDS-tricine/polyacrylamide gel electrophoresis profiles of arrowtooth flounder powder and SDS marker: Lane 1, SDS marker (8-210 kda); Lane 2, AES; Lane 3, EHS; Lane 4, HFS; Lane 5, HFIS; Lane 6, AEIS; Lane 7, EHIS; Lane 8, AIP. AES=alkali extracted soluble protein fraction; EHS=enzymatic hydrolyzed soluble fraction; HFS=heated soluble fraction; HFIS=heated insoluble fraction; AEIS=alkali extracted insoluble protein fraction; EHIS=enzymatic hydrolyzed insoluble fraction; AIP=Intact powder.

FIG. 3 shows rheology properties of emulsions containing arrowtooth flounder protein powders. G′ and G″ indicate storage modulus and loss modulus, respectively. AES=alkali extracted soluble protein fraction; EHS=enzymatic hydrolyzed soluble fraction; HFS=heated soluble fraction.

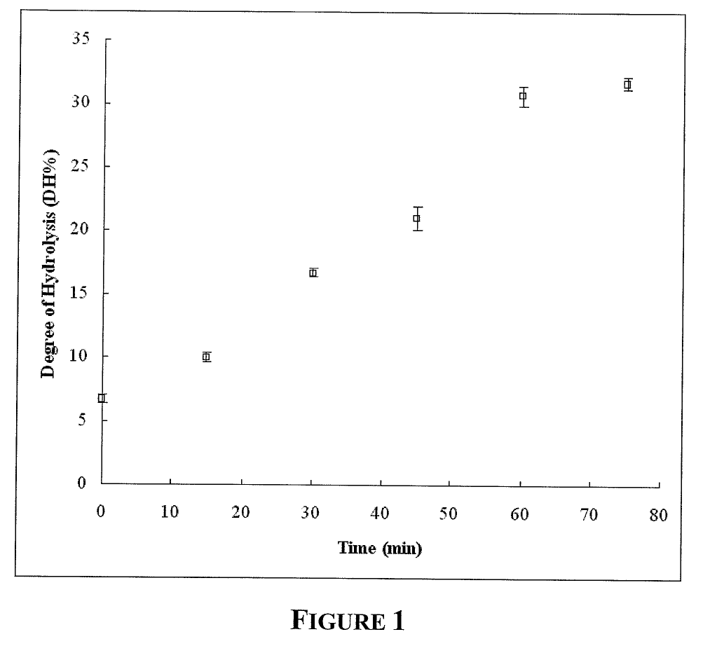

Data shown in FIGS. 1-3 from Sathivel and Bechtel. 2007. Journal of Food Biochemistry. (In Press).

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DESCRIPTION

The present invention can be understood more readily by reference to the following detailed description of the invention and the Examples included therein.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which may need to be independently confirmed.

### A. DEFINITIONS

As used in the specification and the appended claims, the singular forms “a,” “an” and “the” include plural referents unless the context clearly dictates otherwise. Thus, for example, reference to “a functional group,” “an alkyl,” or “a residue” includes mixtures of two or more such functional groups, alkyls, or residues, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

As used herein, the term “soluble protein” refers to relatively hydrophilic protein content. In general, soluble protein has a higher affinity for water than for oils. In one aspect, soluble protein has a sufficiently low molecular weight so as to allow solubility in water. In one aspect, “soluble protein” refers to protein isolated from aqueous phase in the disclosed methods.

As used herein, the term “insoluble protein” refers to relatively hydrophobic protein content. In general, insoluble protein has a relatively low affinity for water. In one aspect, insoluble protein does not have a sufficiently low molecular weight so as to allow solubility in water. In one aspect, “insoluble protein” refers to protein collected with the solid or semi-solid phase in the disclosed methods.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds can not be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

It is understood that the compositions disclosed herein have certain functions. Disclosed herein are certain structural requirements for performing the disclosed functions, and it is understood that there are a variety of structures that can perform the same function that are related to the disclosed structures, and that these structures will typically achieve the same result.

### B. COMESTIBLES

In one aspect, the invention relates to powdered, protein-rich comestibles. A powdered, protein-rich comestible can comprise a protein content of at least about 65%, a moisture content of less than about 5%, and a lipid content of less than about 10%, wherein the powder has an average particle size of less than about 65 μm.

1. Protein Sources

In one aspect, comestibles can be derived from animal protein sources, for example, from fish sources. In a further aspect, the comestible is derived from raw fish product. Fish can provide an excellent source of very digestable and high quality protein. The raw fish product can be, for example, fish fillets, whole fish, or fish trimmings. Typically, the internals and optionally the heads and/or skins are removed. Typically, the fish bodies are coarsely ground with, for example, a chopper.

The raw fish product can be derived from salt water fish sources and/or fresh water fish sources. Suitable fish sources include arrowtooth flounder, cod, pollock, and rock fish.

High quality protein powder can be developed from low price wild marine fish that are underutilized. In one aspect, the raw fish product comprises arrowtooth flounder. Arrowtooth flounder (Atheresthes stomias) is an underutilized flatfish that is found in large amounts in the Alaskan waters. In the Bering Sea and Aleutian Islands, the National Marine Fisheries Service has estimated the annual exploitable biomass of the arrowtooth flounder at 576,000 metric tons [NOAA. 2003. Catch Statistics—2002. www.fakr.noaa.gov./sustainable fisheries/catchstats.htm.]. Arrowtooth flounder fillet contains approximately 5% lipid, 77.4% moisture, 17% protein and 1.1% ash. Using arrowtooth flounder as human foods is challenging due to proteolytic enzymes that soften the flesh during cooking, making it undesirable for many consumers. One alternative to enhance utilization is to produce protein powder from arrowtooth flounder fillets. Proteins from arrowtooth flounder can be converted into a higher value food ingredient suitable for use as an emulsifier and food supplement. Thus, in one aspect, the raw fish product has a significant content of proteolytic enzymes.

In one aspect, the fish source can be whitefish, specifically, Coregonus lavaretus. In a further aspect, the fish source can be any of several different species of fish in the coregonus family, for example, lake white fish (Coregonus clupeaformis), round whitefish (Coregonus cylindraceum) also known as frostfish, cisco or lake herring (Coregonus artedii). In a further aspect, the fish source can be any of several species of oceanic deep water fish with fins, for example, cod (Gadus morhua), whiting (Merluccius bilinearis), and haddock (Melanogrammus aeglefinus), hake (Urophycis), or pollock (Pollachius).

In a yet further aspect, the fish source can be the flesh of any of many types of fish, including, for example, one or more of Mountain whitefish (Prosopium williamsoni), Inconnu (Stenodus leucichthys), the chimaerae (Callorhinchus milii and Hydrolagus ogilbyi), some atherinopsids, the Atlantic menhaden (Brevoortia tyrannus), the cape whitefish (Barbus andrewi), a hiodontid (Hiodon tergisus), some malacanthids, some salangids, and/or the white steenbras (Lithognathus lithognathus).

2. Protein Content

Typically, the disclosed comestibles have a protein content of at least about 70%. For example, the protein content can be at least about 75%, at least about 80%, at least about 85%, at least about 90%, or at least about 95%, relative to the total weight of the comestible. In one aspect, of the total protein content of the disclosed comestibles, at least about 80%, at least about 85%, at least about 90%, at least about 95%, or at least about 97%, relative to the total protein content of the comestible, comprise soluble proteins.

In one aspect, insoluble proteins have been substantially removed. That is, in a further aspect, insoluble proteins can be substantially absent from the comestible.

In one aspect, the comestible has an essential amino acid content (mg of amino acid/g protein) higher than the recommended values for human adults [FAO/WHO. 1990. Protein quality evaluation. Report of a joint FAO/WHO expert consultation held in Bethesda, Md. 4-8 Dec. 1989. Rome.].

For example, in various aspects, the comestible can have an Aspartic acid content of at least about 75 or at least about 80 mg of amino acid/g protein, a Threonine content of at least about 35 or at least about 40 mg of amino acid/g protein, a Serine content of at least about 40 mg or at least about 45 mg of amino acid/g protein, a Glutamic acid content of at least about 150 mg or at least about 200 mg of amino acid/g protein, a Proline content of at least about 80 mg or at least about 85 mg of amino acid/g protein, a Glycine content of at least about 20 mg or at least about 25 mg of amino acid/g protein, an Alanine content of at least about 30 mg or at least about 35 mg of amino acid/g protein, a Valinea content of at least about 50 mg or at least about 60 mg of amino acid/g protein, a Methionine content of at least about 25 mg or at least about 30 mg of amino acid/g protein, an Isoleucinea content of at least about 45 mg or at least about 50 mg of amino acid/g protein, a Leucine content of at least about 80 mg or at least about 90 mg of amino acid/g protein, a Tyrosine content of at least about 45 mg or at least about 50 mg of amino acid/g protein, a Phenylalanine content of at least about 45 mg or at least about 50 mg of amino acid/g protein, a Histidine content of at least about 25 mg or at least about 30 mg of amino acid/g protein, a Lysine content of at least about 80 mg or at least about 85 mg of amino acid/g protein, and/or an Arginine content of at least about 40 mg or at least about 45 mg of amino acid/g protein.

3. Moisture Content

Typically, the disclosed dried comestibles have a moisture content of less than about 5%. For example, the moisture content can be less than about 4%, less than about 3%, less than about 2%, less than about 1%, or less than about 0.5%.

4. Lipid Content

In one aspect, the disclosed comestibles are low fat so there is minimum lipid oxidation and rancidity. Typically, the disclosed comestibles have a lipid content of less than about 10%. For example, the lipid content can be less than about 9%, less than about 8%, less than about 7%, less than about 6%, less than about 5%, less than about 4%, less than about 3%, less than about 2%, or less than about 1%.

It is understood that the lipid content of a disclosed comestible can be subsequently increased by the addition of one or more animal and/or vegetable fat sources. It is also understood that the lipid content of a disclosed comestible can be subsequently decreased by defatting, for example, in the following manner:

First, it is preferable to heat the fish bodies usually to 70 to 100° C., preferably to 95 to 100° C., usually for 20 to 60 minutes, preferably for 30 to 40 minutes. Although the heating process is not particularly restricted, it is preferable to employ vapor or boiling water therefor. Then the fat-rich fish bodies are coarsely ground with, for example, a chopper and fats are removed therefrom. The defatting can be carried out by, for example, adding warm water ranging from room temperature to 100° C., preferably from room temperature to 75° C., to the coarsely ground fish bodies in an amount one to five times, preferably once or twice, as much as the fish bodies and pouring the resulting mixture into a dacanter, while maintaining the above water temperature, at a feed rate of 0.5 to 5 t/hr, preferably 1 to 2 t/hr, to thereby defat the fish bodies. This procedure can be repeated several times, preferably once or twice, if required. The defatting can be continued until the fat content of the coarsely ground fish bodies is lowered to 20% by weight or less, preferably 5% by weight or less and still preferably 3% by weight or less.

5. Particle Size

The disclosed comestibles can be provided with a small particle size that allows a better texture, which cannot be typically achieved with dried muscle protein. Typically, the disclosed comestibles have an average particle size of less than about 65 μm. For example, the average particle size can be less than about 60 μm, less than about 55 μm, or less than about 50 μm.

In a further aspect, the average particle size can range from about 15 μm to about 45 μm, for example, from about 20 μm to about 35 μm. In a further aspect, at least about 50% of the particles in the powder have a particle size of from about 20 μm to about 35 μm. In a further aspect, at least about 75% of the particles in the powder have a particle size of from about 15 μm to about 45 μm.

Particle size can be determined by, for example, dynamic light scattering and/or laser light diffraction measurements.

In one aspect, the disclosed comestibles can be provided at a particle size (e.g., an average particle size of less than about 65 μm) smaller than that exhibited in conventional protein powders (e.g., an average particle size of greater than about 65 μm). A decrease in powder particle size generally produces a significant increase in protein solubility. That is, the disclosed comestibles can be provided as microparticles having a greater solubility than that of conventional (i.e., otherwise identical, but having an average particle size of greater than about 65 μm) protein powders. Further, greater surface area results in easier, faster, and more complete mixing when the disclosed comestibles are incorporated into food products.

In a further aspect, smaller particle size generally means quicker digestion and faster utilization. Additionally, smaller particles have greater total surface area for greater uptake into the bloodstream. That is, the disclosed comestibles can be provided as particles having a greater digestion rate than that of conventional (i.e., otherwise identical, but having an average particle size of greater than about 65 μm) protein powders.

In one aspect, the particle size of the disclosed comestibles can be acheived in the absence of enzymatic digestion, for example, by spray drying.

6. Additives

One or more additives are optionally present in the comestible or the mixture providing the comestible. That is, in one aspect, one or more additives can be included during preparation of the comestible. It is also contemplated that any one or more additives can be specifically and/or substantially omitted from the mixtures and comestibles.

a. Emulsifiers

In one aspect, the mixture can further comprise an emulsifier. Suitable examples include egg yolk (lecithin), mustard, surfactants, and proteins. In a further aspect, the emulsifier comprises one or more of sodium cassinate, whey protein, or isolated soy protein.

b. Texturizers

In one aspect, the comestible can further comprise a texturizer, for example, one or more of sodium cassinate or lecithin.

In one aspect, a texturizer can be a thickener. Such can be added to increase viscosity without substantially modifying its other properties, such as taste, thereby providing body, increase stability, and improve suspending action. Food thickeners are frequently based on polysaccharides (starches or vegetable gums) or proteins (egg yolks, demi-glaces, or collagen). Common examples are agar, alginin, arrowroot, carageenan, collagen, cornstarch, fecula, furcellaran, gelatin, katakuri, pectin, rehan, roux, tapioca, guar gum, locust bean gum, and xanthan gum. Fruit puree, for example tomato puree, can add thickness as well as flavor.

c. Flavorings

In one aspect, the comestible can further comprise a flavoring. The flavoring can be natural or artificial. Suitable examples include one or more of farm products rich in carbohydrates, such as rice, wheat, corn, potato and sweet potato; powders obtained by processing the same, such as rice starch, wheat starch, corn starch and potato starch; processed/denatured starch such as gelatinized starch and dextrin; sugars such as sucrose, honey and starch sugar; fruits such as apple, orange, strawberry, and grape; and fruit juices. Further suitable examples include artificial sweeteners (including saccharin, aspartame, sucralose, neotame, and acesulfame potassium) and flavor enhancers. In a further aspect, the flavoring comprises fruit puree. Added berry extracts can provide antioxidants to the powder.

In one aspect, a flavoring can be strawberry, chocolate, or vanilla flavoring. In a further aspect, a flavoring can be apple, strawberry, chocolate, vanilla, cherry, orange, lemon, lime, raspberry, caramel, cinnamon, banana, peanut, spearmint, almond, coconut, pear, grape, blueberry, blackberry, apricot, hazelnut, mango, pineapple, peach, watermelon, kiwi, papaya, passion fruit, pomegranate, or peppermint.

It is also contemplated that one or more flavor enhancers can be added. Taste or flavor enhancers are largely based on amino acids and nucleotides manufactured as sodium or calcium salts. Suitable flavor enhancers include glutamic acid salts (e.g., monosodium glutamate), guanylic acid salts, inosinic acid salts, and 5′-ribonucleotides salts.

It is also contemplated that one or more substances can be added to alter the odor of the comestible. Suitable odor modifying substances include diacetyl, isoaamyl acetate, cinnamic aldehyde, ethyl propionate, limonene, ethyl-(e,z)-2,4-decadienoate, allyl hexanoate, ethyl maltol, methyl salicylate, and benzaldehyde.

It is also understood that one or more herbs, spices, and/or condiments can be added.

In one aspect, a flavoring can also alter the taste characteristics of the comestible. Thus, undesired tastes can be reduced, minimized, or eliminated. In a further aspect, a flavoring can also alter the odor characteristics of the comestible. Thus, undesired odors can be reduced, minimized, or eliminated.

d. Enzymes

In one aspect, exogenous enzymes can be added to the mixture or to the comestible. Examples of the enzymes capable of hydrolyzing proteins include proteinases such as acrosin, urokinase, uropepsin, elastase, enteropeptidase, cathepsin, kallikrein, kininase 2, chymotrypsin, chymopapain, collagenase, streptokinase, subtilisin, thermolysin, trypsin, thrombin, papain, pancreatopeptidase, ficin, plasmin, renin, reptilase and rennin; peptidases such as aminopeptidases including arginine aminopeptidase, oxycinase and leucine aminopeptidase, angiotensinase, angiotensin converting enzyme, insulinase, carboxypeptidases including arginine carboxypeptidase, kininase 1 and thyroid peptidase, dipeptidases such as carnosinase and prolinase and pronase; and other proteases which are optionally denatured as well as compositions thereof.

Examples of the microorganisms capable of decomposing proteins to be used in the present invention include molds belonging to the genera Ascergillus, Mucor, Rhizopus, Penicillium and Monascus; lactic acid bacteria belonging to the genera Streptococcus, Pediococcus, Leuconostoc and Lactobacillus, bacteria such as Bacillus natto and Bacillus subtilis; and yeasts such as Saccharomyces ellicsuideus, Saccharomyces cerevisiae and Torula as well as variants and compositions thereof.

In one aspect, exogenous enzymes are not added. In a further aspect, exogenous enzymes are substantially absent from the mixture.

e. Other

A comestible can be further supplemented with other components such as other animal protein sources, vegetable protein sources, animal and vegetable fat sources, inorganic salts, e.g., common salt, sodium phosphate or sodium polyphosphate, perfumes, seasonings, taste improvers, antibacterial agents, water, enzymes and/or microorganisms acting on fats and carbohydrates, emulsifiers, colorants, vitamins, preservatives, sweeteners, amino acids, highly unsaturated fatty acids, vegetable extracts, and flavorings, without departing from the scope of the invention. These additives can be added in any step during the disclosed processes.

Examples of vegetable protein sources to be used as the additives include vegetable proteinous materials obtained from, for example, soybean, peanut, cottonseed, sesami, sunflower and wheat, defatted products thereof, concentrated products thereof and proteins isolated therefrom.

Examples of animal protein sources to be used as the additives include milk and milk products such as animal milk, defatted milk, condensed milk, whole-fat milk powder, defatted milk powder, reconstituted milk powder, butter, cream and cheese; meat such as beef, horseflesh, pork, and mutton, fowls of poultry such as chicken, duck, goose, turkey and others; processed meat such as dry meat and smoked meat; egg and egg products such as egg, dry egg, frozen egg, yolk, and albumen; fish meat and processed fish meat such as minced fish meat and ground fish meat; and other animal proteinous sources such as liver.

Examples of animal and vegetable fat sources to be used as additives include animal fats such as lard, beef tallow, mutton tallow, horse tallow, fish oil, whale oil and milk fat; vegetable fats such as soybean oil, linseed oil, safflower oil, sunflower oil, cottonseed oil, kapok oil, olive oil, wheat germ oil, corn oil, palm oil, palm kernel oil, sal fat, illipe fat, Borneo taro oil, and coconut oil; processed fats obtained by hydrogenating, transesterifying, or fractionating the same; and processed fat products such as butter, cream, margarine, and shortening.

Examples of vitamins to be used as additives include vitamin A, vitamin B1, vitamin B2, vitamin B12, vitamin C, vitamin D, pantothenic acid, vitamin E, vitamin H, vitamin K, vitamin L, vitamin M, nicotinic acid, vitamin P, thioctic acid, tioctamide, vitamin R, vitamin S, vitamin T, vitamin U, vitamin V, vitamin W, vitamin X, vitamin Y, lutein and orotic acid. Examples of said amino acids to be used as additives include L-glutamic acid (salt), L-glutamine, glutathione, glycylglycine, D,L-alanine, L-alanine, γ-aminobutyric acid, γ-aminocaproic acid, L-arginine (hydrochloride), L-aspartic acid (salt), L-aspargine, L-citrulline, L-tryptophan, L-threonine, glycine, L-cysteine (derivative), L-histidine (salt), L-hydroxyproline, L-isoleucine, L-leucine, L-lysine (salt), D,L-methionine, L-methionine, L-ornithine (salt), L-phenylalanine, D-phenylglycine, L-proline, L-serine, L-tyrosine and L-valine. Examples of highly unsaturated fatty acids include linoleic acid, linolenic acid, eicosapentaenoic acid, docosahexaenoic acid and glycerides thereof. Examples of vegetable extracts include those obtained from various herbs, asparagus, and ginseng.

It is understood that the disclosed comestibles can be prepared by the disclosed methods of producing and can be used in connection with the disclosed methods of using.

### C. PRODUCING COMESTIBLES

In one aspect, the invention relates to producing a powdered, protein-rich comestible by isolating soluble proteins from a water and comminuted raw fish product mixture and drying the isolate to a powder. In a further aspect, a method comprises the steps of isolating soluble proteins from a mixture of water and comminuted raw fish product; and drying the isolate to a powder. In a further aspect, the isolating step comprises substantially separating oils, soluble proteins, and insoluble proteins; and the method further comprises the steps of mixing water and comminuted raw fish product; optionally adding one or more emulsifiers; optionally adding one or more texturizers; and optionally adding one or more flavorings. In one aspect, the powder has a protein content of at least about 70% and a lipid content of less than about 10%. In a further aspect, a method further comprises heating at a temperature of at least about 75° C. for at least about 30 minutes prior to separating.

1. Mixing

In various aspects, a water and fish product mixture can be provided by chopping, mixing, grinding, mincing, blending, milling, grating, crushing, and/or otherwise comminuting fish product and combining with water. The water can be fresh water or salt water. It is also contemplated that the water can contain one or more additives or agents. In one aspect, mixing comprises homogenization by blending.

Fish product can be further treated by either fermenting the same with an enzyme and/or a microorganism, inactivating said enzyme and/or microorganism and then finely grinding the fermented material; or finely grinding the same, fermenting the same with an enzyme and/or a microorganism and then inactivating said enzyme and/or microorganism; or finely grinding the same while fermenting the same with an enzyme and/or a microorganism and then inactivating the enzyme and/or microorganism.

2. pH

In one aspect, soluble proteins can be isolated from the mixture at a pH range or point. In one aspect, the isolating step is performed at a pH of from about 5 to about 8, for example, from about 6 to about 7. In one aspect, the isolating step is not performed at a pH of less than about 4 or less than about 5. In a further aspect, the isolating step is not performed at a pH of greater than about 10, greater than about 9, or greater than about 8.

3. Separating

In one aspect, separating comprises centrifugation and allowing the mixture to divide into substantially distinct phases of oils, soluble proteins, and insoluble proteins. Typically, the mixture settles into layers as a function of density—an uppermost lipid-containing layer, a middle soluble protein-containing layer, and a lower insoluble protein-containing layer. Optionally, one or more layers can be removed subsequent to settling.

4. Drying

Spray drying is a method of drying a liquid feed through a hot gas. Typically, this hot gas is air, but oxygen-free drying and nitrogen gas can be employed instead. In various aspects, the liquid feed can be a solution, colloid, or suspension. For example, the disclosed mixture and/or isolated layers separated from the mixture can be spray-dried. This process of drying is a one step rapid process and can eliminate additional processing. This technique can be used to remove water from food products; for instance, in the preparation of dehydrated milk.

The liquid feed is typically pumped through an atomizer device that produces fine droplets into the main drying chamber. Atomizers vary with rotary, single fluid, two-fluid, and ultra-sonic designs.

The hot drying gas can be passed as a co-current or counter-current flow to the atomiser direction. The co-current flow enables the particles to have a lower residence time within the system, and the particle separator (typically a cyclone device) operates more efficiently. The counter-current flow method enables a greater residence time of the particles in the chamber and usually is paired with a fluidized bed system.

Spray drying can also be used as an encapsulation technique. A substance to be encapsulated (the load) and an amphipathic carrier (usually some sort of modified starch) are homogenized as a suspension in water (the slurry). The slurry can be then fed into a spray drier, usually a tower heated to temperatures well over the boiling point of water. It is also contemplated that one or more loads (e.g., additives, supplements, or pharmaceuticals) can be encapsulated within the protein powders disclosed herein. As the slurry enters the tower, it is atomized. Partly because of the high surface tension of water and partly because of the hydrophobic/hydrophilic interactions between the amphipathic carrier, the water, and the load, the atomized slurry forms micelles. The small size of the drops (averaging 100 micrometers in diameter) results in a relatively large surface area which dries quickly. As the water dries, the carrier forms a hardened shell around the load.

Load loss is usually a function of molecular weight. That is, lighter molecules tend to boil off in larger quantities at the processing temperatures. Loss can be minimized industrially by spraying into taller towers. A larger volume of air has a lower average humidity as the process proceeds. By the osmosis principle, water can be encouraged by its difference in fugacities in the vapor and liquid phases to leave the micelles and enter the air. Therefore, the same percentage of water can be dried out of the particles at lower temperatures if larger towers are used.

In one aspect, drying comprises spray drying with an ultrasonic atomizing nozzle. In a further aspect, the ultrasonic atomizing nozzle can be emplyed with an Inlet Temperature of from about 100° C. to about 150° C., for example, from about 120° C. to about 140° C., or about 130° C. In a further aspect, the ultrasonic atomizing nozzle can be emplyed with an Outlet temperature of from about 60° C. to about 80° C., for example abut 72-75° C. In a further aspect, the ultrasonic atomizing nozzle can be emplyed with an Utrasonic frequency of about 2% to about 10%, for example, from about 3% to about 6%, or about 4.8%. In a further aspect, the Aspirator can be set to about 40% to about 60%, for example, about 50%. In a further aspect, the feed flow rate can be from about 0.1 mL/min to about 10 mL/min, for example, from about 0.5 mL/min to about 5 mL/min or about 1 mL/min.

It is understood that the disclosed methods can be used to provide the disclosed comestibles and can be used in connection with the disclosed methods of using.

### D. USES

Proteins extracted from fish and fish byproducts are excellent sources of high quality proteins and have desirable emulsifying properties and emulsions exhibit pseudoplastic and viscoelastic characteristics [Sathivel et al., 2004. Properties of protein powders from arrowtooth flounder (Atheresthes stomias) and Herring (Clupea harengus) byproduct. J. Agric. Food Chem. 52, 5040-5046; Sathivel et al., 2005. Functional, nutritional, and rheological properties of protein powders from arrowtooth flounder and their application in mayonnaise. J. Food Sci. 70, 57-63.]. Typically, the disclosed comestibles have a much greater solubility than dried whole fish fillet in aqueous systems.

Isolated fish protein powders have desirable functional properties such as the ability to hold water, fat and emulsifying capacities. Protein from arrowtooth flounder can be converted into a high value protein powder food ingredient. Applications of these ingredients include incorporation into muscle tissue products by injection, tumbling, and coating.

Also provided are uses of the disclosed compositions and products. In one aspect, the invention relates to low-fat, protein-rich comestible powders for use as food additives and/or food supplements, for example, high quality protein for the fitness and body building markets, infant formula, and formulas for the elderly.

Also provided are kits related to the disclosed compositions.

### E. EXPERIMENTAL

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Methodology

a. Preparation of Arrowtooth Flounder Soluble Protein Solution

Fresh arrowtooth flounder (Atheresthes stomias) skinless boneless fillets (AF) were obtained from a commercial fish processing plant in Kodiak, Ak., and within 1 hr they were stored at −40° C. until further processed. The fillets were thawed overnight at 4° C. and ground using a Hobart grinder (K5SS, Hobart Corporation, Troy, Ohio) through a 7 cm diameter plate having 12 mm diameter openings, and subsequently ground through a plate with 6 mm diameter openings.

A 500 g sample of ground AF was mixed with an equal volume of distilled water (23° C.) and homogenized in a Waring blender (Waring Products Div., New Hartford, Conn.) for 2 min. The mixture was continuously stirred for 60 min at 85° C. The heated suspension was centrifuged at 2,560×g for 15 min, resulting in three separate phases: the semisolid phase at the bottom containing insoluble protein which was not used and the lighter liquid phase at the top, which was not used. The heavier liquid middle layer was separated for developing flavored arrowtooth protein powder for human consumption.

b. Preparation of Flavored Arrowtooth Flounder Solution

The strawberry flavored arrowtooth flounder protein sample was made by adding 70 g of water and 10 g sodium caseinate into a grinder, which was stirred for 2 min as 21° C. A 20 g sample of freshly prepared strawberry or other puree was added to the sodium caseinate solution and the mixture was homogenized for 4 min. A 40 g sample of arrowtooth flounder soluble (heavier liquid middle layer) was added to the mixture and homogenized for 2 min.

C. Drying of Strawberry Flavored Arrowtooth Protein Solution

A Buchi mini spray dryer (Laboratoriums-Technik, Flawil, Switzerland) was used to dry the solution containing arrowtooth flounder soluble protein. The solution was pumped to the ultrasonic atomizing nozzle (Sono Tek Corporation) using a syringe pump (Sono Tek Corporation), and the nozzle was vibrated at a frequency at 120 kHz. The atomization spray produced by ultrasonic atomizing nozzle resulted from the break up of unstable capillary waves. The high frequency required for the nozzle was provided by a broadband ultrasonic generator. The nozzle was operated at 120 kHz. The feed rate, inlet temperature and outlet temperature for drying the solution was 1 mL/min, 130° C., and 72-75° C., respectively. Example drying conditions are summarized in Table 1.

TABLE 1
Processing condition for spray dryer
Processing conditions

| | |
|---|---|
| Inlet Temperature | 130° C. |
| Out let temperature | 72-75° C. |
| Utrasonic frequency | 4.8% |
| Aspirator | 50% |
| Feed flow rate | 1 mL/min |

d. Protein, Lipid, and Moisture Analysis

Samples were analyzed in triplicate for moisture using the AOAC standard methods 930.15 and 942.05, respectively (AOAC 1995). Fat content was determined using dichloromethyl ether as a solvent in an automated ASE-200 fat extractor (Dionex Corporation, Sunnyvale, Calif.). Nitrogen content was determined in triplicate using the Leco FP-2000 Nitrogen Analyzer (LECO Corporation, MI). The protein content was calculated as percent nitrogen times 6.25. Protein, moisture, and lipid contents for examples are summarized in Table 2.

TABLE 2
Protein, Moisture, and Lipid Content
Content

| | |
|---|---|
| Protein (%) | 74.8 |
| Moisture (%) | 5.3 |
| Lipid (%) | 8.6 |

e. Amino Acid, Mineral, and Particle Size Analysis

Amino acid profiles were determined by the AAA Service Laboratory Inc., Boring, Oreg. Samples were hydrolyzed with 6N HCl and 2% phenol at 110° C. for 22 h. Amino acids were quantified using a Beckman 6300 analyzer with post column ninhydrin derivatization. Tryptophan and cysteine contents were not determined. Amino acid profiles for examples are summarized in Table 3.

TABLE 3
Amino acid composition

| Amino acid | Content | EAA^{b} |
|---|---|---|
| Aspartic acid | 80.1 | |
| Threonine^{a} | 39.1 | 9 |
| Serine | 45.3 | |
| Glutamic acid | 207.4 | |
| Proline | 83.7 | |
| Glycine | 23.4 | |
| Alanine | 35.6 | |
| Valine^{a} | 60.4 | 13 |
| Methionine^{a} | 28 | 17 |
| Isoleucine^{a} | 50.1 | 13 |
| Leucine^{a} | 92.8 | 19 |
| Tyrosine | 49.7 | |
| Phenylalanine^{a} | 48 | |
| Histidine^{a} | 27 | 16 |
| Lysine^{a} | 84.4 | 16 |
| Arginine^{a} | 44.3 | |
| TEAA | 474.1 | |
| TAA | 999.3 | |
| TEAA/TAA (%) | 47.4 | |

*Data expressed as mg of amino acid per g protein. Tryptophan was not determined.
^{a}Essential amino acids.
^{d}methionine + cysteine.
TEAA = total essential amino acids;
TAA = total amino acids.

Samples for mineral analysis were ashed overnight at 550° C. Residues from ashing were digested overnight in an aqueous solution containing 10% (v/v) hydrochloric acid and 10% (v/v) nitric acid. Minerals were analyzed by inductively coupled plasma optical emission spectroscopy on a Perkin Elmer Optima 3000 Radial ICP-OES (PerkinElmer Life and Analytical Sciences, Inc., Boston, Mass.). Mineral contents for examples are summarized in Table 4.

TABLE 4
Mineral content

| Minerals | SFAF |
|---|---|
| N (%) | 12.20 |
| P (%) | 0.55 |
| K (%) | 0.84 |
| Ca (%) | 0.11 |
| Mg (%) | 0.06 |
| Na (ppm) | 8799 |
| Cu (ppm) | 2.52 |
| Zn (ppm) | 29 |
| Mn (ppm) | <1 |
| Fe (ppm) | 64 |
| S (ppm) | 0.53 |
| Cd (ppm) | <.01 |
| Pb (ppm) | 0.53 |
| Sr (ppm) | 8.7 |
| As (ppm) | 7.07 |
| Co (ppm) | <.15 |
| Mo (ppm) | 0.35 |
| Se (ppm) | <.40 |
| B (ppm) | 4.41 |

Microtrac Particle Size Analyzers were used to determine particle size distribution of the powder. Particle size distribution for an example is summarized in Table 5.

TABLE 5
Particle size distribution

| Particle size (microns) | Particle distribution (%) |
|---|---|
| 62 | 3.6 |
| 44 | 15.2 |
| 31 | 28.3 |
| 22 | 30.4 |
| 16 | 16.2 |
| 11 | 2.9 |
| 7.8 | 1.4 |
| 5.5 | 1.1 |
| 2.8 | 0.56 |
| 1.9 | 0.32 |
| 1.4 | 0.12 |

2. Analytical

Comparisons of the functional and physical properties of proteins made from arrowtooth flounder (AF) using different methods were made. Functional and physical properties of fish protein powders made from AF fillets using three methods—heating and fractionation (HF), enzymatic hydrolysis and fractionation (EH), and alkali protein extraction and fractionation (AE)—were compared.

Soluble and insoluble fish protein powders were made from arrowtooth flounder (AF) fillets using three methods, which were heating and fractionation (HF), enzymatic hydrolysis (EH), and alkali protein extraction (AE). The AF powders were compared and physical, chemical and rheological properties evaluated. The alkali protein extraction soluble (AES) (89.6%) and enzymatic hydrolysis soluble (EHS) (84.8%) powders had higher protein contents than other protein powders (72.6-77.8%). Both heating and fractionation soluble (HFS) and heating and fractionation insoluble (HFIS) powders were whiter than the other protein powders. HFS and EHS had the highest nitrogen solubility values and EHS had the highest emulsion stability values. SDS electrophoresis indicated AES and alkali protein extraction insoluble (AEIS) protein powders had higher molecular weight protein bands, while EHS, enzymatic hydrolysis insoluble (EHIS) and HFS protein powders were substantially hydrolyzed and had an abundance of low molecular weight peptides. The flow and viscoelastic properties of the emulsions prepared with soluble AF were investigated using a parallel plate rheometer. The power law model was used to determine the flow behavior index (n), and consistency index (K). The emulsion containing AES had the highest K value (85.3 Pa·s) and the lowest value was for EHS (27.3 Pa·s). Soluble arrowtooth powders exhibited pseudoplastic behavior and viscoelastic characteristics.

a. Heat Fractionated Protein Extraction

The heated soluble fraction (HFS) and heated insoluble protein fraction (HFIS) were made from the arrowthooth flounder fillets according to the method of Sathivel et al. [Sathivel, S., Bechtel, J. P., Babbitt, J., Prinyawiwatkul, W., Negulescu, I. I. and Reppond, K. D. 2004. Properties of protein powders from arrowtooth flounder (Atheresthes stomias) and Herring (Clupea harengus) byproduct. J. Agric. Food Chem. 52, 5040-5046]. A 500 g sample of ground AF was mixed with an equal volume of distilled water (23° C.) and homogenized in a Waring blender (Waring Products Div., New Hartford, Conn.) for 2 min. The mixture was continuously stirred for 60 min at 85° C. The heated suspension was centrifuged at 2,560×g for 15 min, resulting in three separate phases: the semisolid phase at the bottom containing insoluble protein, the heavier liquid phase in the middle containing soluble proteins, and the lighter liquid phase at the top containing crude lipids. The heavier liquid middle layer was separated, and freeze-dried. The resulting HFS and HFIS were vacuum-packed and stored at 4° C. until analyzed. The experiment was replicated three times.

b. Enzymatic Hydrolysis Protein Extraction (EH)

An enzymatic hydrolysis process analogous to that used by Liceaga-Gesualdo et al. [Liceaga-Gesualdo, A. M. and Li-Chan, E. C. Y. 1999. Functional properties of hydrolysates from herring (Clupea harengus). J. Food Sci. 64, 1000-1004.] and Hoyle et al. [Hoyle, N. T. and Merritt, J. H.1994. Quality of fish protein hydrolysates from herring (Clupea harengus). J. Food Sci. 59, 76-79, 129.] was employed. The commercial proteolytic enzyme used was Alcalase obtained from the Novo Nordisk, Franklinton, N.C. The mince (500 g) was mixed with distilled water (500 g) and homogenized in a Waring blender for 2 min. The mixture was adjusted to pH 8.0 and 50° C. with constant stirring and enzyme was added to the mince (0.5 g enzymes per 100 g of protein). Sample was continuously stirred at 50° C. with the Alcalase for 75 min and then the enzyme inactivated by increased temperature to 85-90° C. for 15 min. The heated suspension was centrifuged at 2,560×g for 15 min, resulting in three separate phases: a semisolid phase at the bottom containing insoluble protein, a heavy liquid phase in the middle containing soluble proteins, and a light liquid phase at the top containing the lipid fraction. The lipid layer was removed by aspiration. The semisolid phase and heavy liquid middle layers were removed separately and freeze-dried. The resulting freeze-dried enzymatic hydrolyzed soluble fraction (EHS) and enzymatic hydrolyzed insoluble fraction (EHIS) were placed in vacuum bags and stored at 4° C. until analyzed. The experiment was replicated three times.

c. Degree of Hydrolysis (DH) Time Course

The experiment to determine the effect of hydrolysis time on DH using a method analogous to that of Hoyle et al. [Hoyle, N. T. and Merritt, J. H.1994. Quality of fish protein hydrolysates from herring (Clupea harengus). J. Food Sci. 59, 76-79, 129.] was replicated three times. An equal volume of water was added to a 50-g portion of fish mince and the mixture was adjusted to pH 8.0 and 50° C. Alcalase was added to the mince at 0.5% w/w of protein. At hydrolysis time of 0, 15, 30, 45, 60, and/or 75 min, an aliquot (50 mL) was removed and mixed with 50 mL of 20% trichloroacetic acid (TCA). The 10% TCA-soluble nitrogen and 10% TCA-insoluble nitrogen fractions were obtained by centrifugation at 2,560×g for 15 min. The supernatant was decanted and analyzed for nitrogen by a combustion method using the Leco FP-2000 nitrogen analyzer (LECO Corporation, MI). The degree of hydrolysis (DH) was calculated as:

$$DH = \frac{Soluble N in the Sample}{Total N in the Sample} \times 100$$

A steady increase in % DH was observed with increased hydrolysis time (FIG. 1). Samples hydrolyzed with Alcalase for 75 min had the highest DH (31.7%), while the sample at 0 min had a DH value of 6.75%. The shape of the hydrolysis curves (FIG. 1) was similar to those previously published for other fish protein hydrolysates [Sathivel, S., Bechtel, J. P., Babbitt, J., Smiley, S., Crapo, C., Reppond, K. D. and Prinyawiwatkul, W. 2003. Biochemical and functional properties of herring (Clupea harengus) byproduct hydrolysates. J Food Sci. 68, 2196-2200; Liceaga-Gesualdo, A. M. and Li-Chan, E. C. Y. 1999. Functional properties of hydrolysates from herring (Clupea harengus). J. Food Sci. 64, 1000-1004; Hoyle, N. T. and Merritt, J. H.1994. Quality of fish protein hydrolysates from herring (Clupea harengus). J. Food Sci. 59, 76-79, 129.]. However, the initial DH for arrowtooth flounder (6.75%) was higher than that reported for red salmon head hydrolysates (1.9 to 3.8%) by Sathivel et al. [Sathivel, S., Bechtel, P. J., Babbitt, J., Prinyawiwatkul, W., and Patterson, M. 2005. Functional, nutritional, and rheological properties of protein powders from arrowtooth flounder and their application in mayonnaise. J. Food Sci. 70, 57-63.] and for herring byproduct hydrolysates (3.4 to 4.4%) by Sathivel et al. [Sathivel, S., Bechtel, J. P., Babbitt, J., Smiley, S., Crapo, C., Reppond, K. D. and Prinyawiwatkul, W. 2003. Biochemical and functional properties of herring (Clupea harengus) byproduct hydrolysates. J. Food Sci. 68, 2196-2200.]. Without wishing to be bound by theory, it is believed that protein hydrolysis caused by endogenous proteolytic enzymes present in the arrowtooth flounder muscle contributed to the higher DH values.

d. Alkali Protein Extraction (AE)

Alkali soluble protein fraction (AES) and alkali insoluble protein fraction (AEIS) were extracted according to the method of Kristinsson et al. [Kristinsson, H. G., Theodore, A. E., Demir, N. and Ingadottir B. 2005. A comparative study between acid and alkali-aided processing and surimi processing for the recovery of proteins from channel catfish muscle. J. Food Sci, 70, C298-C306.]. A 500 g sample of ground AF sample was diluted in 4° C. deionized water (1:9) and homogenized in a Waring blender for 2 min. The pH of the mixture was shifted to 11 using 2M NaOH and then centrifuged at 6981×g for 20 min to separate the soluble aqueous phase and insoluble fraction (AEIS). The soluble protein fraction (AES) was then precipitated by adjusting the pH to 5.5 using 2M H₂SO₄, and the precipitate collected by centrifugation at 6981×g for 20 min. Both soluble (AES) and insoluble (AEIS) fractions were freeze dried and the dried fractions were placed in vacuum bags and stored at 4° C. until analyzed. The experiment was replicated three times.

e. Proximate Composition and Yield of Powders

Samples were analyzed in triplicate for moisture and ash contents using the AOAC standard methods 930.15 and 942.05, respectively [AOAC. 1995. Official Methods of Analysis. 16th ed. Association of Official Analytical Chemists: Arlington, Va.]. Fat content was determined using dichloromethyl ether as solvent in an automated ASE-200 fat extractor (Dionex Corporation, Sunnyvale, Calif.). Nitrogen content was determined in triplicate using the Leco FP-2000 Nitrogen Analyzer (LECO Corporation, MI). The protein content was calculated as percent nitrogen times 6.25.

The yield of the fraction was calculated by determining the dried protein powder weight as a percentage of the total wet weight of raw material [Hoyle, N. T. and Merritt, J. H. 1994. Quality of fish protein hydrolysates from herring (Clupea harengus). J. Food Sci. 59, 76-79, 129.].

$$Yield \% = \frac{Weight of protein powder ( g )}{Raw material wet weight ( g )} \times 100$$

The protein content of EHS (84.4%) and AES (89.6%) was significantly (p<0.05) higher than that of other AF protein powders (Table 6). The protein contents of protein powder hydrolysates (EHS and EHIS) ranged from 72.6 to 84.8%, which were similar to those reported for herring protein hydrolysates (77-88%) [Sathivel, S., Bechtel, J. P., Babbitt, J., Smiley, S., Crapo, C., Reppond, K. D. and Prinyawiwatkul, W. 2003. Biochemical and functional properties of herring (Clupea harengus) byproduct hydrolysates. J Food Sci. 68, 2196-2200; Liceaga-Gesualdo, A. M. and Li-Chan, E. C. Y. 1999. Functional properties of hydrolysates from herring (Clupea harengus). J. Food Sci. 64, 1000-1004; Hoyle, N. T. and Merritt, J. H. 1994. Quality of fish protein hydrolysates from herring (Clupea harengus). J. Food Sci. 59, 76-79, 129.] and reported for Atlantic salmon protein hydrolysates (72-88%) [Kristinsson, H. G., Theodore, A. E., Demir, N. and Ingadottir B. 2005. A comparative study between acid and alkali-aided processing and surimi processing for the recovery of proteins from channel catfish muscle. J. Food Sci, 70, C298-C306.].

Moisture values for the protein powders ranged from 2.4 to 6.6%; however, large differences in ash values were noted with HFS having a value of 9.3% and EHIS a low value of 2.0%. The fat contents of the AEIS, HFIS, and EHIS insoluble fractions were 16.6, 20.0, and 22.9%, respectively. The insoluble fractions had much higher (p<0.05) percent fat values than that of soluble fractions, possibly due to the incomplete rupturing of fat cells and presence of membrane lipids in the insoluble fractions. The ash content of HFS (9.3%) and EHS (7.1%) were higher (p<0.05) than that of the other arrowtooth flounder protein powder samples (1.7% to 4.6%). Ash contents ranging from 4.8 to 17.7% were reported for fish protein powders [Sathivel, S., Bechtel, J. P., Babbitt, J., Prinyawiwatkul, W., Negulescu, I. I. and Reppond, K. D. 2004. Properties of protein powders from arrowtooth flounder (Atheresthes stomias) and Herring (Clupea harengus) byproduct. J. Agric. Food Chem. 52, 5040-5046].

The yield of arrowtooth solids for the soluble and insoluble fractions ranged from 5.1% to 10.1% (Table 6). As expected, the AIP yield of 16.8% was higher than any of the soluble and insoluble fractions. When the yields between soluble and insoluble fractions from a common method were compared the only significant difference was between the heat treated soluble and insoluble fractions. Only for the hydrolyzed samples (EHS and EHIS) was the soluble fraction yield numerically greater that the insoluble value. All insoluble fractions had more (p<0.05) lipid than their soluble counter parts. Factors affecting solubility and protein extraction from fish tissues include concentration and particle size of suspended tissues, extraction time, temperature, pH, type and concentration of extraction salts [Kahn, L. N., Berk, Z., Pariser, E. R., Goldblith, S. A., and Flink, J. M. 1974. Squid protein isolate:

Effect of processing conditions on recovery of yields. J. Food Sci. 39, 592-595.], and freshness of the raw materials.

TABLE 6
Proximate Composition Percentages and Yield (%) of Powders*

| Sample | Protein | Ash | Moisture | Lipid | Yield |
|---|---|---|---|---|---|
| AIP | 77.0 ± 0.3^{b} | 4.6 ± 0.2^{b} | 3.6 ± 0.3^{b} | 14.9 ± 0.2^{b} | 16.8 ± |
| | | | | | 0.1^{a} |
| HFS | 77.8 ± 2.2^{b} | 9.3 ± 0.7^{a} | 6.6 ± 0.2^{a} | 6.4 ± 3.0^{c} | 5.1 ± |
| | | | | | 0.8^{c} |
| HFIS | 75.2 ± 0.3^{b} | 1.7 ± 0.1^{d} | 3.1 ± 0.2^{b} | 20.0 ± 0.1^{a} | 10.1 ± |
| | | | | | 0.6^{b} |
| EHS | 84.8 ± 1.1^{a} | 7.1 ± 0.2^{a} | 3.7 ± 1.1^{b} | 4.4 ± 0.1^{c} | 7.9 ± |
| | | | | | 0.3^{bc} |
| EHIS | 72.6 ± 4.8^{b} | 2.0 ± 0.4^{cd} | 2.4 ± 0.3^{b} | 22.9 ± 4.8^{ab} | 6.7 ± |
| | | | | | 1.7^{bc} |
| AES | 89.6 ± 1.5^{a} | 4.1 ± 1.7^{bc} | 2.6 ± 1.1^{b} | 3.8 ± 2.0^{c} | 6.0 ± |
| | | | | | 1.6^{c} |
| AEIS | 76.0 ± 1.2^{b} | 4.3 ± 1.0^{b} | 3.1 ± 1.0^{b} | 16.6 ± 1.0^{ab} | 7.5 ± |
| | | | | | 2.0^{bc} |

*Values are means ± SD of 3 determinations.
^{abcd}Mean values with the same letter in each column are not significantly different (p > 0.05).
AIP = Intact powder;
HFS = heated soluble fraction;
HFIS = heated insoluble fraction;
EHS = enzymatic hydrolyzed soluble fraction;
EHIS = enzymatic hydrolyzed insoluble fraction;
AES = alkali extracted soluble protein fraction;
AEIS = alkali extraction procedure insoluble protein fraction.
[Data from Sathivel and Bechtel. 2007. Journal of Food Biochemistry. (In Press).]

f. Amino Acid and Mineral Analysis

Amino acid profiles were determined by the AAA Service Laboratory Inc., Boring, Oreg. Samples were hydrolyzed with 6NHC1 and 2% phenol at 110° C. for 22 h. Amino acids were quantified using a Beckman 6300 analyzer with post column ninhydrin derivatization. Tryptophan and cysteine contents were not determined.

Samples for mineral analysis were ashed overnight at 550° C. Residues from ashing were digested overnight in an aqueous solution containing 10% (v/v) hydrochloric acid and 10% (v/v) nitric acid. Samples were analyzed for Ag, Ca, Cd, Cu, K, Hg, Mg, Mn, Ni, P, Pb, Sr, and Zn by inductively coupled plasma optical emission spectroscopy on a Perkin Elmer Optima 3000 Radial ICP-OES (PerkinElmer Life and Analytical Sciences, Inc., Boston, Mass.).

The amino acid contents of the arrowtooth flounder protein powder samples are listed in Table 7. The essential amino acid contents (mg of amino acid/g protein) of all the samples were higher than the recommended values for human adults [FAO/WHO. 1990. Protein quality evaluation. Report of a joint FAO/WHO expert consultation held in Bethesda, Md. 4-8 Dec. 1989. Rome.]. However, the values for essential amino acids from the arrowtooth flounder protein powders were generally below infant requirements FAO/WHO/UNU. 1985. Energy and protein requirements. Report of joint FAO/WHO/UNU expert consultation. Geneva: World Health Organization Technical Rep. Ser. 724.]. As a percent of total amino acids, the total essential amino acid content was lower for HFS (47.6%) than other protein powder samples. The lysine content of arrowtooth protein powder samples ranged from 92.6 to 108.2 mg of amino acid per g protein, and was higher than that reported for pollock protein powders [Sathivel, S, and Bechtel, P. J. 2006. Properties of soluble protein powders from pollock. Inter. J. Food Sci. Technol. 41, 520-529.]. All samples exceeded the reported requirement level of threonine (43 mg of amino acid per g protein) and isoleucine (46 mg of amino acid per g protein) for infants except HFS.

TABLE 7
Amino Acid (mg of Amino Acid/g Protein) Composition of Powders*

| Amino Acids | AIP | HFS | HFIS | EHS | EHIS | AES | AEIS |
|---|---|---|---|---|---|---|---|
| Aspartic acid | 99.8 | 109.4 | 104.2 | 102.9 | 97.6 | 108 | 101.6 |
| Threonine^{a} | 50.6 | 42.9 | 52.7 | 48.7 | 52.9 | 48.4 | 51.9 |
| Serine | 43.9 | 43.2 | 40.4 | 46.1 | 43.8 | 42.1 | 45.7 |
| Glutamic acid | 147.6 | 189.6 | 132 | 157 | 130.6 | 162 | 145.1 |
| Proline | 32.3 | 27.6 | 37 | 31.6 | 33.9 | 33.1 | 39.8 |
| Glycine | 42.1 | 48.6 | 40 | 44.2 | 38.4 | 32.4 | 54.8 |
| Alanine | 65.1 | 80.8 | 55.1 | 72.5 | 58.7 | 60 | 63 |
| Valine^{a} | 55.5 | 45.1 | 59.8 | 52.8 | 60.5 | 53.4 | 54.9 |
| Methionine^{a} | 37.3 | 31.6 | 39.6 | 34.3 | 40.6 | 38.2 | 36.1 |
| Isoleucine^{a} | 52 | 37.2 | 58.1 | 45.6 | 60.2 | 52.3 | 49.2 |
| Leucine^{a} | 87.6 | 91.2 | 88 | 89.7 | 89.5 | 90.2 | 84.2 |
| Tyrosine | 43.7 | 25.2 | 50.8 | 34.6 | 51.8 | 43.4 | 41.6 |
| Phenylalanine^{a} | 47.5 | 31.9 | 52.2 | 39.2 | 52.5 | 44.6 | 42.6 |
| Histidine^{a} | 24 | 18.1 | 26.4 | 22.8 | 26.1 | 24.1 | 23.2 |
| Lysine^{a} | 96.4 | 108.1 | 95.8 | 108.2 | 92.6 | 101 | 95.7 |
| Arginine^{a} | 68.2 | 69.6 | 68 | 69.5 | 69.3 | 66.7 | 70.5 |
| TEAA | 519.1 | 475.7 | 540.6 | 510.8 | 544.2 | 518.9 | 508.3 |
| TAA | 993.6 | 1000.1 | 1000.1 | 999.7 | 999 | 999.9 | 999.9 |
| TEAA/TAA (%) | 52.2 | 47.6 | 54.1 | 51.1 | 54.5 | 51.9 | 50.8 |

*Analyses are single determinations and tryptophan and cysteine were not determined.
^{a}Essential amino acids for children
TEAA = total essential amino acids;
TAA = total amino acids.
AIP = Intact powder;
HFS = heated soluble fraction;
HFIS = heated insoluble fraction;
EHS = enzymatic hydrolyzed soluble fraction;
EHIS = enzymatic hydrolyzed insoluble fraction;
AES = alkali extracted soluble protein fraction;
AEIS = alkali extracted insoluble protein fraction.
[Data from Sathivel and Bechtel. 2007. Journal of Food Biochemistry. (In Press).]

All the AF protein powder samples had low calcium levels because the AF fillets did not have bones (Table 8). P levels ranged from a high of 1.36% in HFS to a low of 0.17% in AEIS. The AEIS fraction had the lowest concentration of all P, K, Ca and Mg, due to the process of making the sample. The P and K contents of AF powders were lower than that reported for pollock protein powers [Sathivel, S, and Bechtel, P. J. 2006. Properties of soluble protein powders from pollock. Inter. J. Food Sci. Technol. 41, 520-529.]. The zinc content of HFS (3 ppm) and EHS (5 ppm) was lower than that of other AF protein powders and levels of Pb and Cd were low in all samples.

TABLE 8
Mineral Content of Powders*

| | AIP | HFS | HFIS | EHS | EHIS | AES | AEIS |
|---|---|---|---|---|---|---|---|
| P (%) | 0.64 | 1.36 | 0.34 | 0.88 | 0.41 | 0.47 | 0.17 |
| K (%) | 1.57 | 3.71 | 0.66 | 2.47 | 0.68 | 0.9 | 0.27 |
| Ca (%) | 0.04 | 0.06 | 0.03 | 0.05 | 0.03 | 0.07 | 0.02 |
| Mg (%) | 0.12 | 0.24 | 0.07 | 0.18 | 0.07 | 0.2 | 0.01 |
| Na (ppm) | 3155 | 7941 | 1232 | 5181 | 1269 | 9725 | 12760 |
| Cu (ppm) | <0.1 | <0.1 | 0.06 | <0.1 | 0.21 | 0.36 | 3.01 |
| Zn (ppm) | 14 | 3 | 18 | 5 | 22 | 15 | 13 |
| Mn (ppm) | <1 | <1 | <1 | <1 | <1 | 2 | <1 |
| Cd (ppm) | 0.01 | 0.07 | 0.12 | 0.02 | 0.15 | 0.04 | 0.25 |
| Ni (ppm) | 0.05 | <.01 | 2.2 | 0.12 | 0.05 | 0.46 | 0.21 |
| Pb (ppm) | 0.26 | 0.37 | 0.24 | <0.01 | <0.01 | <0.01 | 0.21 |
| Ag(ppm) | <0.01 | <0.01 | <0.01 | <0.01 | <0.01 | <0.01 | <0.01 |
| Sr (ppm) | 1.2 | 2.68 | 0.98 | 2.08 | 0.55 | 3.08 | 0.48 |
| As (ppm) | n/d | n/d | n/d | n/d | n/d | n/d | n/d |
| Hg (ppm) | n/d | n/d | n/d | n/d | n/d | n/d | n/d |

*Values are single analysis expressed on a dry weight basis
AIP = Intact powder;
HFS = heated soluble fraction;
HFIS = heated insoluble fraction;
EHS = enzymatic hydrolyzed soluble fraction;
EHIS = enzymatic hydrolyzed insoluble fraction;
AES = alkali extracted soluble protein fraction;
AEIS = alkali extracted insoluble protein fraction.
n/d = not detected.
[Data from Sathivel and Bechtel. 2007. Journal of Food Biochemistry. (In Press).]

g. Color of the Powders

Color of samples was determined using a Minolta Chromameter (Model CR-300, Minolta Co., Ltd, Osaka, Japan) and reported as L*, a*, and b* values. L* describes the lightness of the sample, a* intensity in red (a*>0), and b* intensity in yellow (b*>0). Whiteness, chroma and hue angle were calculated as follows:

Whiteness=100−[(100−L*)²+a*²+b*²]^{1/2}

Chroma=[a*²+b*²]^{1/2}

Hue angle=tan⁻¹(b*/a*)

Color characteristics of the AF protein powders are listed in Table 9. HFS and HFIS powders were lightest (p<0.05) with L* values of 83.5 and 81.3, respectively. AEIS and EHIS were darkest with L* values of 60.2 and 65.7, respectively. EHS had the lowest b* value (6.7), while EHIS and HFIS were the most yellowish with b* values of 22.1 and 22.9, respectively. HFS had higher whiteness value than the other AF samples (Table 9). Of all samples, the hue angle value of AIP (86.3) was lowest and HFS (103.3) highest than other AF protein powders, indicating more redness. The water activities of all example dried powders were low, ranging from 0.21 to 0.38 (Table 9).

TABLE 9
Color L*A*B* and Water Activity of Powders made using Three Different Processes**

| Samples | L* | a* | b* | Whiteness | Hue angle | Chroma | Water activity |
|---|---|---|---|---|---|---|---|
| AIP | 71.8 ± 2.7^{b} | 1.2 ± 0.0^{a} | 17.6 ± 0.4^{b} | 66.7 ± 22.0^{b} | 86.3 ± 0.1^{g} | 17.6 ± 0.4^{b} | 0.34 ± 0.04^{ab} |
| HFS | 83.5 ± 3.5^{a} | −4.0 ± 0.2^{e} | 16.8 ± 0.6^{b} | 76.0 ± 2.0^{a} | 103.3 ± 0.4^{b} | 17.3 ± 0.6^{b} | 0.38 ± 0.04^{a} |
| HFIS | 81.3 ± 2.1^{a} | −0.2 ± 0.1^{c} | 22.9 ± 0.4^{a} | 70.4 ± 1.1^{b} | 90.5 ± 0.2^{c} | 22.9 ± 0.4^{a} | 0.35 ± 0.02^{ab} |
| EHS | 70.3 ± 3.2^{bc} | −2.0 ± 0.2^{d} | 6.7 ± 0.5^{e} | 69.5 ± 3.0^{b} | 106.6 ± 0.5^{a} | 7.0 ± 0.5^{e} | 0.34 ± 0.01^{ab} |
| EHIS | 65.7 ± 2.1^{cd} | 1.1 ± 0.2^{a} | 22.1 ± 0.4^{a} | 59.2 ± 1.6^{c} | 87.1 ± 0.4^{f} | 22.1 ± 0.3^{a} | 0.31 ± 0.02^{b} |
| AES | 72.6 ± 4.2^{b} | 0.3 ± 0.1^{b} | 16.0 ± 0.5^{c} | 68.2 ± 3.4^{b} | 88.8 ± 0.3^{d} | 16.0 ± 0.5^{c} | 0.21 ± 0.0^{c} |
| AEIS | 60.2 ± 4.1^{d} | 0.4 ± 0.1^{b} | 9.7 ± 0.5^{d} | 59.0 ± 3.8^{c} | 87.8 ± 0.6^{e} | 9.8 ± 0.5^{d} | 0.29 ± 0.0^{b} |

**Values are means ± SD of 3 determinations.
AIP = Intact powder;
HFS = heated soluble fraction;
HFIS = heated insoluble fraction;
EHS = enzymatic hydrolyzed soluble fraction;
EHIS = enzymatic hydrolyzed insoluble fraction;
AES = alkali extracted soluble protein fraction;
AEIS = alkali extracted insoluble protein fraction.
^{abcdefg}Means with the same letter in each column are not significantly different (p > 0.05).
[Data from Sathivel and Bechtel. 2007. Journal of Food Biochemistry. (In Press).]

h. SDS-Page Electrophoresis

The SDS tricine/polyacrylamide gel electrophoresis system used was a Photodyne Foto/Force 300 power supply (Hartland, Wis.) and a single sided vertical gel electrophoresis system (Owl Separation Systems, Portsmouth, N.H.), under reducing conditions according to Schagger et al. [Schagger, H. and Von Jagow, G. 1987. Tricine-sodium dodecyl sulfate-polyacrylamide gel electrophoresis for the separation of protein in the range of 1 to 100 kDa. Anal. Biochem. 166, 368-379.]. Novex Precast 10-20% Tricine gels (Invitrogen Life Technologies, Carlsbad, Calif.) were used, and ColorBurst molecular mass standards were purchased from Sigma-Aldrich (Number C 4105, St. Louis, Mo.). The protein bands were visualized by staining the gels with coomassie blue.

i. Functional Properties of Powders

Three separate experiments for all arrowtooth flounder protein samples were conducted and results are reported on a protein content basis. Nitrogen solubility was determined following a procedure analogous to that of Morr et al. [Morr, V., German, B., Kinsella, J. E., Regenstein, J. M., Van Buren, J. P., Kilara, A., Lewis, B. A. and Mangino, M. E. 1985. A collaborative study to develop a standardized food protein solubility procedure. J. Food Sci. 50, 1715-1718.]. A 500 mg sample of AF protein powder sample was dispersed in 50 mL of 0.1 M NaCl at pH 7.0. The solution was stirred for 1 h at 25° C. and centrifuged at 2,560×g for 30 min. The supernatant was analyzed for nitrogen content using a Leco FP-2000 Nitrogen Analyzer. Percent nitrogen solubility of arrowtooth flounder protein samples was calculated as:

$$Nitrogen solubility ( \% ) = \frac{Supernatant nitrogen content}{Total sample nitrogen content} \times 100$$

Emulsifying stability (ES) was evaluated according to the method of Yatsumatsu et al. [Yatsumatsu, K., Sawada, K., and Moritaka, S. 1972. Whipping and emulsifying properties of soybean products. Agric. Biol. Chem. 36, 719-727.]. A 500 mg of AF sample was transferred into a 250 mL beaker and dissolved in 50 mL of 0.1 M NaCl, and then 50 mL of soybean oil (Hunt-Wesson Inc., Fullerton, Calif.) was added. The homogenizer (model 6-105-AF, Virtis Co, Gardner, N.Y.), equipped with a motorized stirrer controlled by a rheostat, was immersed to half the depth of the mixture and operated for 2 min at 100% output at 120 V to make an emulsion. From the emulsion, three 25 mL aliquots were immediately taken and transferred into three 25 mL graduated cylinders. The emulsions were allowed to stand for 15 min at 25° C. and then the aqueous volume was read. ES (%) was calculated as [(total volume aqueous volume)/total volume]×100.

The fat adsorption capacity (FA) of the arrowtooth flounder samples was determined by placing 500 mg of AF sample into a 50 mL centrifugal tube and adding 10 mL of soybean oil [Shahidi, F., Han, X. Q., and Synowiecki, J. 1995. Production and characteristics of protein hydrolysates from capelin (Mallotus villosus). Food Chem. 53, 285-293.]. The sample was thoroughly mixed with a small steel spatula, held for 30 min at 25° C. with intermittent mixing every 10 min, and then centrifuged at 2,560×g for 25 min. The quantity of oil in mL was corrected using an oil density of 0.9112 g/mL. Free oil was then decanted and the fat absorption of the sample was determined from the weight difference. FA was expressed in terms of milliliters of fat adsorbed by 1 g of arrowtooth flounder protein.

Nitrogen solubility values for the AF protein powders are shown in Table 10. The soluble fractions (HFS 80.6% and EHS 74%) had high solubility values; however, AES had a low nitrogen solubility value of 14.0%. The low AES nitrogen solubility value was due to the preparation procedure that extracted intact myofibrillar proteins that were denatured and precipitated by 10% TCA. Solubility values of 55.8 to 85.7% were reported for pollock protein powders [Sathivel, S, and Bechtel, P. J. 2006. Properties of soluble protein powders from pollock. Inter. J. Food Sci. Technol. 41, 520-529.], and values ranging from 63.4 to 87.2% for herring protein powders were reported [Sathivel, S., Bechtel, J. P., Babbitt, J., Prinyawiwatkul, W., Negulescu, I. I. and Reppond, K. D. 2004. Properties of protein powders from arrowtooth flounder (Atheresthes stomias) and Herring (Clupea harengus) byproduct. J. Agric. Food Chem. 52, 5040-5046.]. High nitrogen solubility values are often important in formulated food systems for enhancing product appearance and providing smooth mouth feel [Peterson, B. R. 1981. The impact of the enzymatic hydrolysis process on recovery and use of proteins. In Enzymes and Food Processing, pp 149-175, Elsevier Applied Science Publishers London, UK.].

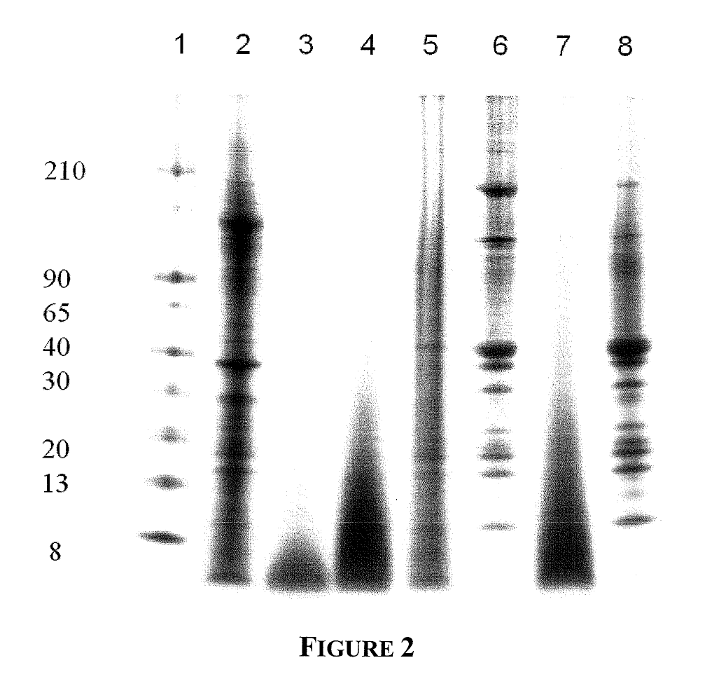

SDS-PAGE electrophoresis (FIG. 2) showed the protein powders fell into two groups. The banding patterns for HFS, EHF, and EHIS had an absence of high molecular weight protein chains above 40 kDa and an abundance of smaller proteins and peptides. The small molecular weight peptides resulted from the hydrolysis due to addition of Alcalase or the action of endogenous proteolytic enzymes in the arrowtooth fillets. The banding patterns for AES, AEIS, and AIP showed the presence of high molecular weight proteins including bands which corresponded to major muscle contractile proteins such as actin. HFS, EHS, and EHIS had electrophoresis protein banding patterns indicating most of the protein was of small molecular weight; however, only the soluble fractions (HFS and EHS) had high percent nitrogen solubility values (80.6% and 74.0%). This indicated additional physico-chemical properties of the proteins and peptides can play a role. Chobert et al. [Chobert, J. M., Bertrand-Harb, C., and Nicolas, M. G. 1988. Solubility and emulsifying properties of caseins and whey proteins modified enzymatically by trypsin. J. Agric. Food Chem. 36, 883-889.] reported that smaller peptides had higher solubility than the intact proteins.

Emulsifying stability of AF protein powders ranged from 58.6 to 77.1% (Table 10). In other studies, ES values of 64.5 to 66.4 were reported for herring protein powders [Sathivel, S., Bechtel, J. P., Babbitt, J., Prinyawiwatkul, W., Negulescu, I. I. and Reppond, K. D. 2004. Properties of protein powders from arrowtooth flounder (Atheresthes stomias) and Herring (Clupea harengus) byproduct. J. Agric. Food Chem. 52, 5040-5046.], 52 to 61% for enzymatically hydrolyzed Atlantic salmon muscle protein [Kristinsson, H. G. and Rasco, B. A. 2000. Biochemical and functional properties of Atlantic salmon (Salmo salar) muscle proteins hydrolyzed with various alkaline proteases. J. Agric. Food Chem. 48, 657-666.], and values of 48.6 to 54.2% for hydrolyzed herring byproducts [Sathivel, S., Bechtel, J. P., Babbitt, J., Smiley, S., Crapo, C., Reppond, K. D. and Prinyawiwatkul, W. 2003. Biochemical and functional properties of herring (Clupea harengus) byproduct hydrolysates. J Food Sci. 68, 2196-2200.]. Gauthier et al. [Gauthier, S. F., Paquin, P., Pouliot, Y. and Turgeon, S. 1993. Surface activity and related functional properties of peptides obtained from whey proteins. J. Dairy Sci, 76, 321-328.] stated that factors such as protein solubility and hydrophobicity also play major roles in emulsifying properties.

Fat binding/adsorption capacity is an important functional characteristic of ingredients used in the meat and confectionery industries. AIP, HFS and AEIS exhibited greater fat adsorption values (p<0.05) than HFIS and EHS (Table 10). Fat adsorption capacity values have been reported that ranged from 3.9 to 11.5 mL of oil/g protein for herring protein powders [Sathivel, S., Bechtel, J. P., Babbitt, J., Prinyawiwatkul, W., Negulescu, I. I. and Reppond, K. D. 2004. Properties of protein powders from arrowtooth flounder (Atheresthes stomias) and Herring (Clupea harengus) byproduct. J. Agric. Food Chem. 52, 5040-5046.], 3.7 to 7.3 mL of oil/g protein for hydrolyzed herring byproduct proteins [Sathivel, S., Bechtel, J. P., Babbitt, J., Smiley, S., Crapo, C., Reppond, K. D. and Prinyawiwatkul, W. 2003. Biochemical and functional properties of herring (Clupea harengus) byproduct hydrolysates. J Food Sci. 68, 2196-2200.], and 2.86 to 7.07 mL of oil g protein for Atlantic salmon protein hydrolysates [Kristinsson, H. G. and Rasco, B. A. 2000. Biochemical and functional properties of Atlantic salmon (Salmo salar) muscle proteins hydrolyzed with various alkaline proteases. J. Agric. Food Chem. 48, 657-666.]. The mechanism of fat binding capacity is thought to be mainly due to physical entrapment of the oil.

TABLE 10
Functional Properties of Powders Made Using Three
Different Processes*

| | Nitrogen | Emulsion | Fat Absorption |
|---|---|---|---|
| | Solubility | stability (% | (mL of oil/g of |
| Samples | (%) | emulsified) | protein) |
| AIP | 12.5 ± 1.2^{bc} | 77.1 ± 3.9^{a} | 6.1 ± 0.7^{a} |
| HFS | 80.6 ± 6.3^{a} | 70.3 ± 2.4^{b} | 5.2 ± 0.2^{ab} |
| HFIS | 3.9 ± 0.8^{d} | 63.5 ± 2.0^{c} | 3.8 ± 0.3^{c} |
| EHS | 74.0 ± 5.0^{a} | 79.1 ± 7.1^{a} | 3.6 ± 0.7^{c} |
| EHIS | 2.3 ± 0.8^{d} | 62.2 ± 2.5^{c} | 4.3 ± 0.2^{bc} |
| AES | 14.0 ± 1.1^{b} | 63.1 ± 1.1^{c} | 4.8 ± 0.1^{bc} |
| AEIS | 5.1 ± 1.9^{cd} | 58.6 ± 2.2^{c} | 5.5 ± 0.4^{ab} |

*Values are means ± SD of 3 determinations.
^{abcd}means with the same letter in each column are not significantly different (p > 0.05).
AIP = Intact powder;
HFS = heated soluble fraction;
HFIS = heated insoluble fraction;
EHS = enzymatic hydrolyzed soluble fraction;
EHIS = enzymatic hydrolyzed insoluble fraction;
AES = alkali extracted soluble protein fraction;
AEIS = alkali extracted insoluble protein fraction.
[Data from Sathivel and Bechtel. 2007. Journal of Food Biochemistry. (In Press).]

j. Rheological Properties of Emulsions

Flow properties of the emulsion samples were measured using the AR 2000 Rheometer (TA Instruments, New Castle, Del., USA) fitted with a cone plate geometry (acrylic plates with a 20-mm diameter having a 200 μm gap between the two plates). Each sample was placed in the temperature-controlled parallel plate and allowed to equilibrate at 25±0.1° C. Shear stress was measured at varying shear rates from 0 to 500s⁻¹. The mean values of triplicate samples were reported. The power law was used to analyze the flow properties of the emulsion samples:

σ=Kγⁿ

where σ=shear stress (Pa·s), γ=shear rate (s⁻¹), K=consistency index (Pa·sⁿ), and n=flow behavior index. A plot of log σ versus log γ was constructed. The resulting straight line yielded the magnitude of log K (intercept) and n (slope).

Viscoelastic properties of the emulsions were measured using the AR 2000 Rheometer (TA Instruments, New Castle, Del., USA) fitted with the following plate geometry. The acrylic cone plate was 20-mm in diameter and there was a 200 μm gap between the two plates. Each sample was placed on the parallel plate and the frequency sweep test was conducted at a constant temperature of 25° C.

The flow behavior index (n) and consistency index (K) values of emulsion containing soluble AF powders are listed in Table 11. The flow behavior index values for AES (0.23), EHS (0.24), and HFS (0.39) samples were less than 1.0 (Table 11), which indicated that they were pseudoplastic fluids (Paredes et al. 1989). The flow behavior index value was lower than those reported for emulsion made from arrowtooth flounder soluble protein powders (0.5) [Sathivel, S., Bechtel, P. J., Babbitt, J., Prinyawiwatkul, W., and Patterson, M. 2005. Functional, nutritional, and rheological properties of protein powders from arrowtooth flounder and their application in mayonnaise. J. Food Sci. 70, 57-63]. Values of 0.13 to 0.91 for n have been reported for some commercial emulsions and model emulsions systems [Dickie, A. M. and Kokini, J. L. 1983. An improvement method for food thickness from non-Newtonian fluid mechanics in the mouth. J. Food Sci. 48, 57-61, 65; Steffe, J. F. 1992. Yield stress: Phenomena and measurement. In Advances in Food Engineering, (R P Singh and M A Wirakaratakusumah, eds.) CRC Press, London.]. The K value of AES (85.3 Pa·s) and HFS (37.2) was higher than that of EHS (27.3 Pa·s) (Table 11). These values were much higher than those previously reported for emulsions made from soluble (4.2 and 5.6 Pa·s) arrowtooth protein powders. Higher K values of emulsion samples indicate a more viscous consistency. The viscosity of emulsions containing AES (0.78) and HFS (0.85) had higher (p<0.05) viscosity than that containing EHS (0.25).

Dynamic rheological tests can be used to characterize viscoelastic properties of emulsions. The following equations can be used to define viscoelastic behavior:

$${G}^{′} = [ \frac{{σ}_{o}}{{γ}_{o}} ] cos δ$$

$${G}^{″} = [ \frac{{σ}_{o}}{{γ}_{o}} ] sin δ$$

where G′ (Pa) is the storage modulus, G″ (Pa) is the loss modulus, tan δ is the loss tangent, a is generated stress, and γ is oscillating strain. The storage modulus, G′, characterizes the rigidity of the sample and can be viewed as the magnitude of the energy that is stored in the material per cycle of deformation. The loss modulus, G″, characterizes the resistance of the sample to flow, and is a measure of the energy that is lost through viscous dissipation per cycle of deformation. For a perfectly elastic solid, all the energy is stored, that is, G″ is zero and the stress and the strain will be in phase. In contrast, for a liquid with no elastic properties, all the energy is dissipated as heat, that is G′ is zero and the stress and strain will be out of phase by 90° [Rao, M. A. 1999. Rheology of fluids and semisolids. Principal and applications. An Publishers, Inc, Gaitherburg, Md.].

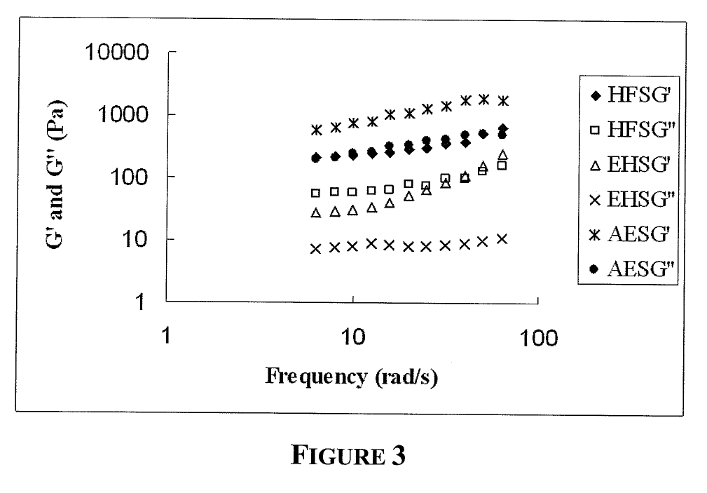

The G′ and G″ of the emulsion samples containing arrowtooth flounder soluble protein powder and arrowtooth flounder insoluble protein powder were determined as a function of frequency at a fixed temperature of 25° C. (FIG. 3). The G′ and G″ values for AES were higher than those of HFS and EHS, which indicated that the viscoelastic characteristics of the AES emulsion was greater than those of HFS and EHS emulsions. Gallegos et al. [Gallegos, C. and Berjano, M. 1992. Linear viscoelastic behavior of commercial and model mayonnaise. J. Rheol. 36, 465-478.] reported that emulsions with a higher oil content had higher G′ and G″ values; however, in this study even though the oil content of the emulsion products were similar, emulsions made with AES had a greater G′ and G″ than those made with HFS and EHS. The higher AES G′ than G″ values indicted that the energy used to deform the material dissipated viscously and were solid-like in behavior [Ferry J. D. 1980. Viscoelastic properties of polymers. New York: John Wiley & Sons.].

All the emulsions containing AF soluble protein powders showed a gradual increase in both G′ and G″ with increasing frequency. Oakenfull et al. [Oakenfull, D., Pearce, J. and Burley, R. W. 1997. Protein Gelation. In Food Proteins and Their Applications, (S. Damodaran, A. Paraf, eds.), Marcel Dekker, Inc, New York.] have stated that high viscosity occurs in the emulsion system due to entanglement and not intermolecular cross-linkages. All example emulsions made with arrowtooth flounder soluble protein powders had higher G′ than G″, which indicate a viscoelastic material with both G′ and G″ being independent of frequency.

TABLE 11
Flow Parameters of Emulsions Containing Soluble Powders*

| Sample | n | K (Pa · s)ⁿ | Viscosity (Pa · s) |
|---|---|---|---|
| AES | 0.23 ± 0.07^{b} | 85.3 ± 26.6^{a} | 0.78 ± 0.03^{a} |
| EHS | 0.24 ± 0.01^{b} | 27.34 ± 0.98^{b} | 0.25 ± 0.02^{b} |
| HFS | 0.39 ± 0.01^{a} | 37.16 ± 3.16^{ab} | 0.85 ± ∀0.07^{a} |

*Values are means ± SD of 3 determinations.
n = flow index; K = consistency index
AES = alkali extracted soluble protein fraction;
EHS = enzymatic hydrolyzed soluble fraction;
HFS = heated soluble fraction.
^{ab}Means with the same letter in each column are not significantly different (p > 0.05).
[Data from Sathivel and Bechtel. 2007. Journal of Food Biochemistry. (In Press).]

k. Statistical Analysis

Mean values from the three separate experiments or replicate analyses were reported. The statistical significance of observed differences among treatment means was evaluated by Analysis of Variance (ANOVA) (SAS Version 8.2, SAS Institute Inc., Cary, N.C.), followed by the post hoc Tukey's studentized range test [SAS. 2002. SAS/STAT Users Guide, version 8.2; SAS Institute: Cary, N.C.].

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for producing a powdered, protein-rich comestible comprising the steps of:
a. isolating soluble proteins from a mixture of water and comminuted raw fish product; and
b. drying the isolate to a powder.

2. The method of claim 1, wherein the isolating step comprises substantially separating oils, soluble proteins, and insoluble proteins; and the method further comprises the steps of:
a. mixing water and comminuted raw fish product;
b. optionally adding one or more emulsifiers;
c. optionally adding one or more texturizers; and
d. optionally adding one or more flavorings.

3. The method of claim 1, wherein the isolating step is performed at a pH of from about 5 to about 8.

4. The method of claim 1, wherein the powder has a protein content of at least about 70% and a lipid content of less than about 10%.

5. The method of claim 1, wherein the powder has an average particle size of less than about 65 μm.

6. The method of claim 1, wherein the raw fish product has a significant content of proteolytic enzymes.

7. The method of claim 1, wherein the raw fish product comprises arrowtooth flounder.

8. The method of claim 1, wherein the raw fish product comprises fish trimmings.

9. The method of claim 2, further comprising the step of heating at a temperature of at least about 75° C. for at least about 30 minutes prior to separating.

10. The method of claim 2, wherein separating comprises centrifugation and allowing the mixture to divide into substantially distinct phases of oils, soluble proteins, and insoluble proteins.

11. The method of claim 2, wherein mixing comprises homogenization by blending.

12. The method of claim 1, wherein drying comprises spray drying with an ultrasonic atomizing nozzle.

13. The product produced by the method of claim 1.

14. A powdered, protein-rich comestible comprising:
a. a protein content of at least about 65%,
b. a moisture content of less than about 5%, and
c. a lipid content of less than about 10%,
wherein the powder has an average particle size of less than about 65 μm.

15. The comestible of claim 14, wherein the protein content is at least about 70%.

16. The comestible of claim 14, wherein at least about 50% of the particles in the powder have a particle size of from about 20 μm to about 35 μm.

17. The comestible of claim 14, wherein at least about 75% of the particles in the powder have a particle size of from about 15 μm to about 45 μm.

18. The comestible of claim 14, wherein the comestible is derived from raw fish product.

19. The comestible of claim 14, wherein the comestible has an essential amino acid content (mg of amino acid/g protein) higher than the recommended values for human adults (FAO/WHO 1990).

20. The comestible of claim 14, wherein insoluble proteins have been substantially removed.
